(19) United States
(12) Patent Application Publication
(10) Pub. No.: US 2011/0259688 A1
(43) Pub. Date: Oct. 27, 2011

(54) FRICTION SHOCK ABSORBER

(76) Inventor: Adil Kanioz, Kocaeli (TR)

(21) Appl. No.: 12/674,420

(22) PCT Filed: Mar. 17, 2009
(86) PCT No.: PCT/IB09/51125

§ 371 Date: Feb. 19, 2010

(30) Foreign Application Priority Data
Mar. 13, 2009 (TR) 2009/01985

(51) Int. Cl. D06F 37/20; F16F 7/09; F16F 7/08

(52) U.S. Cl. 188/381

(57) ABSTRACT

Friction shock absorber (10) comprising at least one cylindrical shock absorber piston (13); at least one shock absorber body (11) that surrounds the shock absorber piston (13), moves telescopically along the same axis (x) with the piston (13); and bears the piston (13) from its end part; characterized by
at least one friction ring (15) which is located between the shock absorber body (11) an the piston (13), and moves in the same axis (x) with the body (11),
at least one lock ring (20) which bears the shock absorber piston (13) on the shock absorber body (11) and prevents the friction ring (15) from getting displaced out of the body (11)
a friction element (16)
   compressed between the inner surface of the friction ring (15) and the outer surface of the shock absorber piston (13).

### FIELD OF THE INVENTION

This invention relates to a friction shock absorber which is used in washing machines wherein the washing drum rotates on the horizontal axis.

### PRIOR ART

Shock absorbers provided in washing machines are generally of two types. In the first type, the damping power is always constant while there occurs some decrease in the power only when it warms up, and causes extra vibration in the small drum movements where low damping is required. In the second type the damping power can be reset in the small drum movements. Thus, both the shock absorber becomes long-lasting and the vibration level of the machine can be reduced.

Among the known embodiments in the art, the European patent application EP 0686720 discloses an absorber comprising a piston moveable between the two springs located at the end of the shaft. The springs used in this absorber are pre-compressed.

The U.S. Pat. No. 4,768,629 discloses a shock absorber wherein a progressive ring is utilized for fastening the spring. As for the United States patent application U.S. Pat. No. 4,955,467, a shock absorber wherein the springs are not fastened on the shaft is disclosed.

The German patent application DE3216152 discloses a shock absorber which moves back and forth inside the body as a result of the inclination of the piston bowls which are fixed on the shaft. The piston herein comprises a plurality of components which are actuated with various mechanisms.

In the Turkish patent application TR 200400107, it is aimed to have a smooth force transition during direction change, by means of directly contacting the conic pieces with the side surface of the friction mat parallel to the axis for the first time. In this design, the plastic piston does not contact the coupling conics. Although this system is very successful, its production cost is high.

In the Unites States patent application US74456098, the Turkish patent application TR 200400107 was taken as basis where a cheaper pipe type was utilized instead of the shaft. The shaft and the spring system are abandoned. However, contrary to the patent application TR 200400107, as the plastic piston is in contact with the plastic body, it can not be successful.

The noise level could not be sufficiently reduced in the systems disclosed in the above mentioned patent applications. Besides, the production cost of the known absorbers is high.

### SUMMARY OF THE INVENTION

The objective of the present invention is to produce the second action upon resetting the friction force in low oscillations by using the damper that provides the first action in the double action absorbers in exactly the same way; and while doing so, to realize a triple action friction shock absorber which provides a third damping action between the first and the second actions by extending the transition over a period of time.

The shock absorber developed for the said objective comprises a carrier piston that contacts the friction element only from its outside, a friction element two sides of which are completely exposed, stopper protrusions disposed with an angle of 45° to each other in the work axis to contact the friction element, canal ribs located in the inner surface of the body for restricting rotation of the piston within the shock absorber body, a shock absorber body having a larger diameter than the piston for keeping the piston away from the inner surface of the body and providing acoustic improvement. The friction element only contacts the stopper protrusions. The friction ring carrying the friction element does not contact the body of the shock absorber.

When the drum of the washing machine is rotating at a high and constant speed, it produces some oscillation. It is sufficient for the shock absorber piston to freely move in the space formed within the machine. The drum vibration of the washing machine is only absorbed by the springs of the washing machine and the transmission of the vibration to the legs of the machine contacting the floor is prevented.

Flexible bearings with symmetrical geometry are formed within the body and on the lock ring that prevents displacement of the friction piston, for the movements which are perpendicular to the work axis of the shock absorber.

The fact that the inventive shock absorber is comprised of few pieces enables the production costs of the shock absorber to be low.

### DETAILED DESCRIPTION OF THE INVENTION

The “Triple action friction shock absorber” realized in order to attain the objectives of the invention is illustrated in the accompanying figures, wherein;

FIG. 1 is the view of the application of the inventive triple action friction shock absorber on the washing machine having a drum rotating on the horizontal axis.

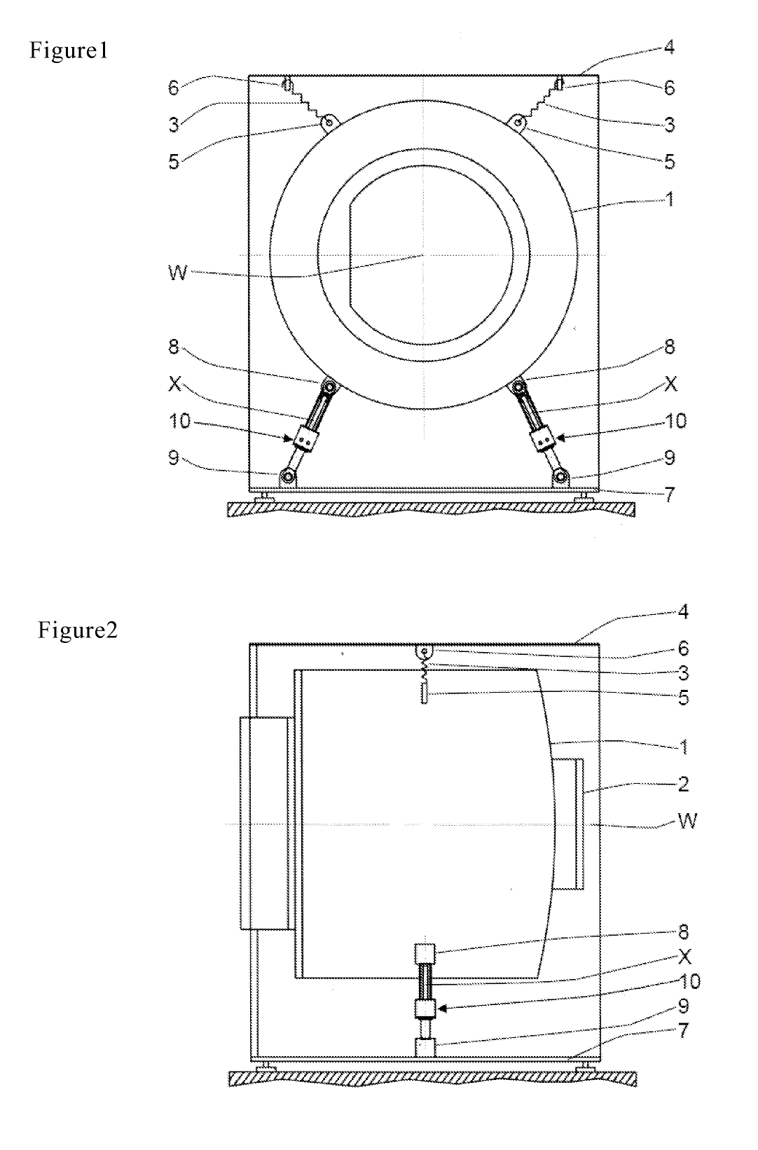

FIG. 2 is the side view of the application of the inventive triple action friction shock absorber on the washing machine having a drum rotating on the horizontal axis.

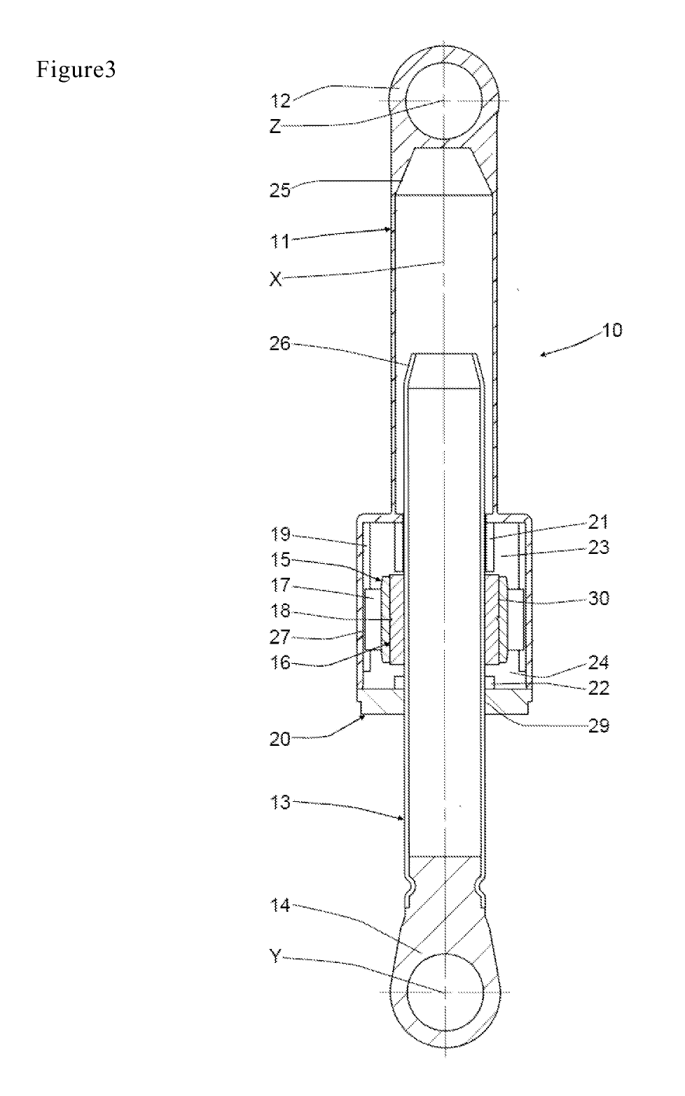

FIG. 3 is the axial sectional view of the inventive triple action friction shock absorber.

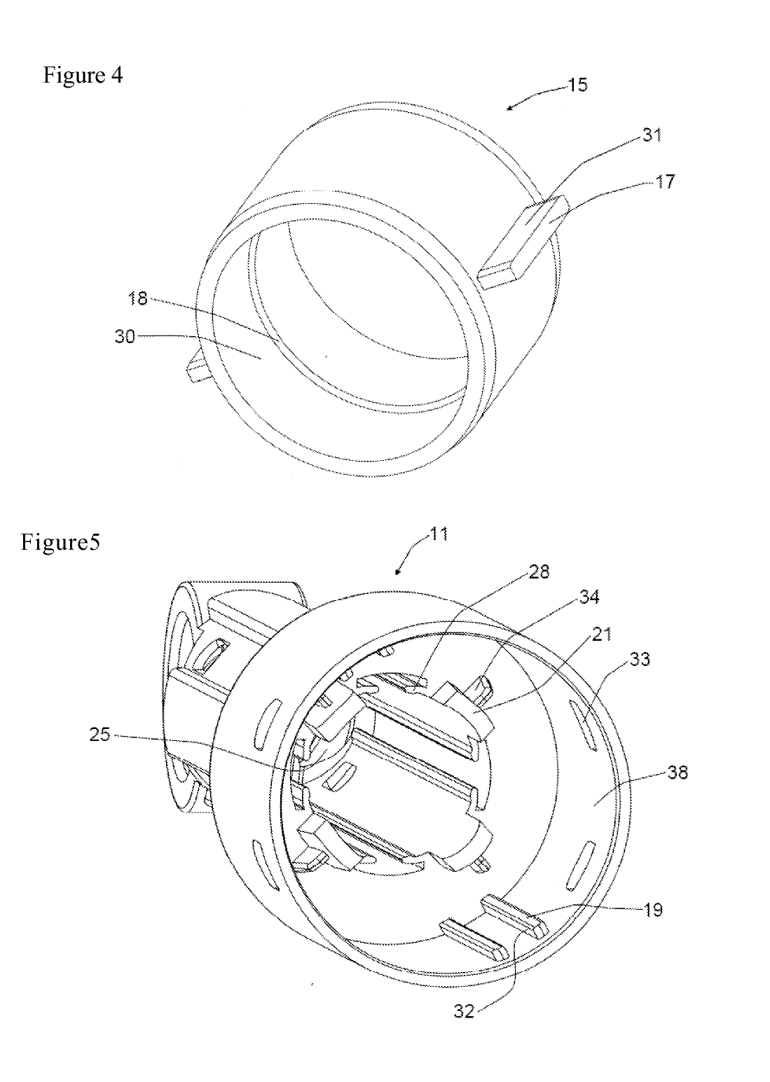

FIG. 4 is the perspective view of the friction ring provided in the triple action friction shock absorber.

FIG. 5 is the perspective view of the shock absorber body in the triple action friction shock absorber.

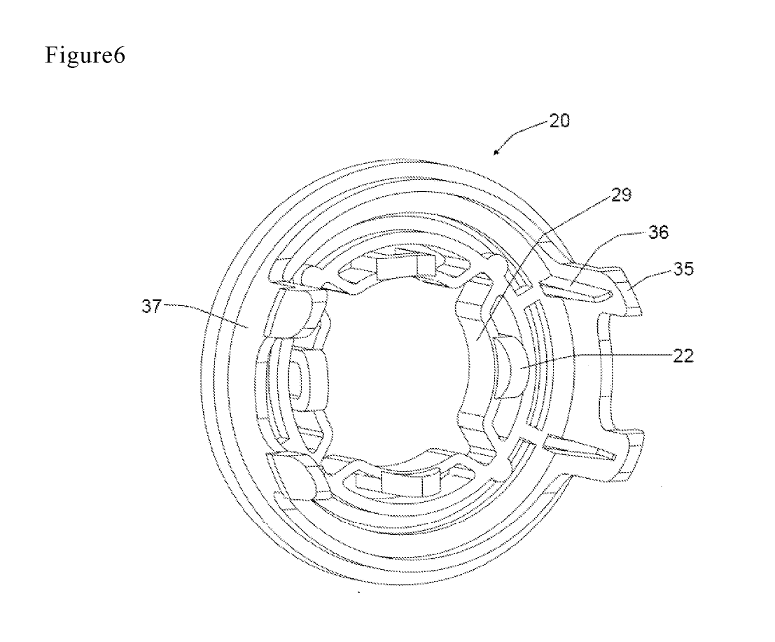

FIG. 6 is the perspective view of the lock ring in the triple action friction shock absorber.

The components in the figures have each been numbered corresponding to the following:
1. Drum
2. Motor
3. Spring
4. Body
5. Drum spring suspension ring
6. Washing machine spring suspension ring
7. Washing machine base
8. Drum bracket
9. Base bracket
10. Triple action friction shock absorber
11. Shock absorber body
12. Shock absorber body connecting element
13. Shock absorber piston
14. Shock absorber piston connecting element
15. Friction ring
16. Friction element
17. Bearing rib
18. Protrusion
19. Friction ring canal rib
20. Lock ring
21. Body stopper protrusion
22. Lock ring stopper protrusion
23. Upper isolation space
24. Lower isolation space
25. Body stopper conic
26. Piston stopper conic
27. Bearing space
28. Body flexible bearings
29. Lock ring flexible bearings
30. Friction ring—friction element contact surface
31. Shock absorber body bearing rib side surface
32. Friction ring canal rib contact surface
33. Lock ring pin hole
34. Body stopper protrusion support rib
35. Lock pin
36. Lock pin support rib
37. Lock ring—shock absorber body contact surface
38. Shock absorber body—lock ring contact surface

The inventive triple action friction shock absorber (10) is preferably used in front loading washing machines. The washing machine, on which the triple action friction shock absorber (10) is applied, comprises a motor (2) on the horizontal axis (W) and a drum (1) rotating by means of the motor (2). The drum (1) is connected to the washing machine body (4) by means of the springs (3) disposed between the drum spring suspension ring (5) and the washing machine spring suspension ring (6) located on the body (4). On the other hand, the drum (1) is coupled to the washing machine base (7) along the X axis by means of at least two shock absorbers (10) mounted between the drum bracket (8) and the base bracket (9) (FIG. 1 and FIG. 2).

The shock absorber piston (13) is coupled to the washing machine base (7) via the base bracket (9) by means of a hinge. The shock absorber piston (13) can move around the axis (Y) of the connecting element (14). The shock absorber body (11) is hingedly connected to the drum bracket (8) and can move around the axis (Z) of the connecting element (12). The shock absorber body (11) is connected to the drum (1) and moves along the axis (X) of the shock absorber. The shock absorber piston (13) can be made of metal or plastic, while the shock absorber body (11) can be produced of a flexible plastic material.

The triple action friction shock absorber basically comprises
at least one cylindrical shock absorber piston (13),
at least one shock absorber body (11) that surrounds the shock absorber piston (13), moves telescopically along the same axis (X) with the piston (13), and bears the piston (13) from its end part,
at least one friction ring (15) which is located between the shock absorber body (11) and the piston (13) and moves in the same axis (X) with the shock absorber body (11),
at least one lock ring (20) which bears the shock absorber piston (13) on the shock absorber body (11) and prevents the friction ring (15) from getting displaced out of the body (11),
a friction element (16) compressed between the inner surface of the friction ring (15) and the outer surface of the shock absorber piston (13).

The movement of the shock absorber body (11) on the shock absorber piston (13) on the X axis is taken under control in two ways depending on the movement of the drum (1).
In the first condition where the drum (1) moves upwards from the machine base (7), as the drum (1) approaches to the uppermost point of the machine body (4), the shock absorber body (11) moves towards the very end point of the shock absorber piston (13) in the direction of the X-axis. Restriction of the said movement is related to the design of the washing machine body (4). When the drum (1) rises and comes to the closest position to the washing machine body (4), the triple action friction shock absorber (10) acquires its longest state, but the shock absorber body (11) does not disengage from the shock absorber piston (13).
In the second condition where the drum (1) moves towards the machine base (7), as the drum (1) unintentionally approaches the machine base (7), that is, the shock absorber body (11) contacts the piston (13), the shock absorber (10) acquires its shortest state, and the body stopper conic (25) located within the shock absorber body (11) contacts the piston stopper conic (26) located at the end part of the shock absorber piston (13) and blocks the downwards movement of the drum (1) in X direction. The body stopper conic (25) and the piston stopper conic (26) contacting each other at this point help reduce formation of noise and vibration and prevent the shock absorber body (11) from being broken by the piston (13).

The movement of the shock absorber piston (13) perpendicular to the X axis within the body (11) is enabled by the body and lock ring flexible bearings (28, 29) provided in the inside of the body (11) and the lock ring (20). The flexible bearings (28) within the shock absorber body (11) and the flexible bearings (29) within the lock ring (20) bear the preferably tubular metal part of the shock absorber piston (13) such that there will be a very slight contact. As the bearings (28, 29) within the body (11) and the ring (20) are flexible, the vibration transferred from the shock absorber piston (13) to the body (11) decreases. Another objective of the flexible bearings (28, 29) is to keep the shock absorber piston (13) exactly on the center of the X-axis of the shock absorber body (11) whereby preventing the friction ring (15) from contacting the shock absorber body (11) along the X-axis. Thus the bearing space (27) between the shock absorber body (11) and the friction ring (15) is formed by the upper and lower isolation spaces (23, 24) which remain above and below the said space (27). Additionally, with the structure formed, the body flexible bearings (28) apply a horizontal force on the shock absorber piston (13). The lower and the upper isolation spaces (23, 24) and the bearing space (27) prevent any contact of the friction ring (15), which compresses the friction element (16) to the shock absorber piston (13), with the shock absorber body (11). This way, they make the transmission of the vibration, which is produced at constant tub speeds from the washing machine drum (1), to the washing machine base (7) in the X axis direction via the shock absorber piston (3) impossible.

The lock ring (20) is the piece that holds together the shock absorber system which is comprised of the shock absorber body (11), shock absorber piston (13) and the friction ring (15). It fits into the lock ring pin hole (33) provided on the shock absorber body (11) in a slightly tightened manner by means of the lock pins (35) provided thereon. There are preferably provided two lock pins (35) on the lock ring (20). When the lock pin (35) fits into the lock ring pin hole (33) on the shock absorber body (11) the lock ring—shock absorber body contact surface (37) and the shock absorber body—lock ring contact surfaces (38) slightly contact and bear each other. Lock pin support ribs (36) are incorporated to the surfaces of the lock pins (35) that fit into the body (11) in order to prevent the lock pins (35) from easily coming off from the shock absorber body (11) and to avoid any movement that might occur on the body (11). The lock ring (20) has important functions such as preventing the friction ring (15) from getting disengaged from the shock absorber body (11) and limiting free motion, and determining the working dimensions of the shock absorber (10).

The function of the friction ring (15) is to compress the friction element (16) onto the shock absorber piston (13) whereby enabling the shock absorber (10) to produce a damping force. In order to achieve this, the friction ring (15) contacts the friction element (16) only from the friction ring—friction element contact surface (30). A circular protrusion (18) is formed around the X axis of the ring (15) inner surface in order to fix the position of the friction element (16) between the shock absorber piston (13) and the friction ring (15) and to prevent displacement thereof. This protrusion is preferably 1 mm×45°.

There are preferably two bearing ribs (17) on the friction ring (15) on the X axis direction and on the same plane. The aim of the bearing rib (17) is to prevent rotation of the shock absorber piston (13) within the shock absorber body (11) around the X-axis. The bearing ribs (17) move in the X axis direction between the friction ring canal ribs (19) located within the shock absorber body (11). During this motion, the contact between the bearing ribs (17) and the friction ring canal ribs (19) occurs only from the side surfaces (31, 32) of the friction ring canal ribs (19). Thus a bearing space forms between the shock absorber body (11) and the friction ring (15). By preferably greasing the shock absorber body bearing rib side surface (31) and the friction ring canal rib contact surfaces (32), formation of noise during contact can be further decreased. The greasing to be applied to these surfaces (31, 32) will also mean greasing applied to the bearing space (27).

Friction force should be produced in order to terminate the free motion of the shock absorber piston (13) and the friction element (16) and the friction ring (15) contacting the shock absorber piston (13) within the shock absorber body (11) (first action) and to damp the movement of the drum (1) towards the washing machine base (second action). In the inventive shock absorber (10), the body stopper protrusions (21) provided within the shock absorber body (11) and the lock ring stopper protrusions (22) provided in the lock ring (20) are used for producing the friction force. The said protrusions (21, 22) can be of variable number. In the preferred embodiment of the invention, there are preferably used 4 stopper protrusions (21, 22) on each of the lock ring and shock absorber body. Furthermore, by means of the circular structure of the stopper protrusions (21, 22), strength of the protrusions against any shocks that might come from the drum (1) is increased. The said protrusions (21, 22) may be in variable lengths. This way, the free working distance (dimension of the first action) of the shock absorber can be adjusted.

In a preferred embodiment of the invention, the body stopper protrusions (21) provided on the shock absorber body (11) are equipped with body stopper protrusion support ribs (34) in order for them to protect (maintain) their structure for a long time. The support ribs (34) on the shock absorber body (11) are not in contact with the friction element (16) and the friction ring (15).

The body (11) stopper protrusions (21) and the lock ring (20) stopper protrusions (22) are located preferably with an angle of 45° to each other around X axis. In constant oscillating drum (1) movements, the friction element (16) and the friction ring (15) operate freely and without contacting the shock absorber body (11). When the oscillation amount of the drum (1) increases, only the friction element (16) contacts with the lock ring (20) stopper protrusions (22) or shock absorber body (11) stopper protrusions (21). When the oscillation amount increases, the friction ring (15) does not contact the stopper protrusions (21, 22) at all and contact of two non-flexible pieces is avoided. Thus, a vibration transmission that might be transferred from the friction element (16) to the machine base (7) via the shock absorber piston (13) is prevented.

Furthermore, since the friction element (16) is fixed between the friction ring (15) and the shock absorber piston (13) only by means of a protrusion (18), contact of the friction element (16) with the stopper protrusions (21, 22) smoothens the transition of the shock absorber (10) from the free motion to the damping (third action).

The production cost of the inventive triple action shock absorber (10) remains at a very low level compared to the shock absorbers used in the prior art, due to the fact that it is easy to mount and that comprised of few pieces.

The invention is not limited to the above described applications and a person skilled in the art can easily develop different embodiments of the invention. The said embodiments should be evaluated within the scope of the protection sought for the invention with the claims.

1. Triple action friction shock absorber (10) comprising at least one cylindrical shock absorber piston (13); at least one shock absorber body (11) that surrounds the shock absorber piston (13), moves telescopically along the same axis (X) with the piston (13), and bears the piston (13) from its end part; characterized by
at least one friction ring (15) which is located between the shock absorber body (11) and the piston (13), and moves in the same axis (X) with the body (11),
at least one lock ring (20) which bears the shock absorber piston (13) on the shock absorber body (11) and prevents the friction ring (15) from getting displaced out of the body (11),
a friction element (16) compressed between the inner surface of the friction ring (15) and the outer surface of the shock absorber piston (13).

2. Triple action friction shock absorber (10) according to claim 1 characterized by the friction ring (15) which enables the friction element (16) to be positioned and fixed on the shock absorber piston (13).

3. Triple action friction shock absorber (10) according to any of the preceding claims characterized by bearing ribs (17) provided on the friction ring (15).

4. Triple action friction shock absorber (10) according to any of the preceding claims characterized by flexible bearings (28, 29) which are provided in the inside of the body (11) and/or the lock ring (20) and which enable movement of the shock absorber piston (13) within the body (11).

5. Triple action friction shock absorber (10) according to any of the preceding claims characterized by flexible bearings (28, 29) that reduce the vibration which results from the movement of the drum and which is transferred from the shock absorber piston (13) to the body (11).

6. Triple action friction shock absorber (10) according to any of the preceding claims characterized by flexible bearings (28, 29) which keep the shock absorber piston (13) in the exact center of the X-axis of the body (11) whereby preventing the friction ring (15) from contacting the body (11) along the X-axis.

7. Triple action friction shock absorber (10) according to any of the preceding claims characterized by lower and upper isolation spaces (23, 24) and a bearing space (27) which prevent contact of the friction ring (15) with the shock absorber body (11).

8. Triple action friction shock absorber (10) according to any of the preceding claims characterized by lower and upper isolation spaces (23, 24) and a bearing space (27) which prevent transfer of the vibration to the washing machine base (7) via the shock absorber piston (13).

9. Triple action friction shock absorber (10) according to any of the preceding claims characterized by the lock ring (20) which holds together the shock absorber body (11), shock absorber piston (13) and the friction ring (15).

10. Triple action friction shock absorber (10) according to any of the preceding claims characterized by the lock pin (35) provided on the lock ring (20).

11. Triple action friction shock absorber (10) according to any of the preceding claims characterized by the lock pin (35) which fits into the lock ring pin hole (33) provided on the shock absorber body (11).

12. Triple action friction shock absorber (10) according to any of the preceding claims characterized by the lock pin support ribs (36) which are incorporated to the lock pins (35) in order to prevent the lock pins (35) from easily coming off from the shock absorber body (11) and to avoid any movement that might occur on the body (11).

13. Triple action friction shock absorber (10) according to any of the preceding claims characterized by a protrusion (18) which is provided on the friction ring (15) and which fixes the position of the friction element (16) between the shock absorber piston (13) and the friction ring (15) and prevents displacement thereof

14. Triple action friction shock absorber (10) according to any of the preceding claims characterized by a circular protrusion (18) which is formed around the X axis of the inner surface of the friction ring (15).

15. Triple action friction shock absorber (10) according to any of the preceding claims characterized in that the circular protrusion (18) is 1 mm×45°.

16. Triple action friction shock absorber (10) according to any of the preceding claims characterized by the body and lock ring stopper protrusions (21, 22) which are provided within the shock absorber body (11) and/or the lock ring (20) and used for producing the friction force.

17. Triple action friction shock absorber (10) according to any of the preceding claims characterized by support ribs (34, 36) used for protecting the structure of the body and lock ring stopper protrusions (21, 22).

18. Triple action friction shock absorber (10) according to any of the preceding claims characterized by body stopper protrusion (21) and lock ring stopper protrusion (22) positioned with an angle of 45° to each other.

19. Triple action friction shock absorber (10) according to any of the preceding claims characterized by friction ring canal rib (19) used for enabling the movement of the friction ring (15) within the shock absorber body (11).

20. Triple action friction shock absorber (10) according to any of the preceding claims characterized by the shock absorber body (11) with a body stopper conic (25) and the shock absorber piston (13) with a piston stopper conic (26) fitting to each other, used for preventing the piston (13) from damaging the shock absorber body (11).

21. Triple action friction shock absorber (10) according to any of the preceding claims characterized in that it is used in front loading washing machines.
